(19) United States
(12) Patent Application Publication
(10) Pub. No.: US 2026/0178220 A1
(43) Pub. Date: Jun. 25, 2026

(54) DATA TRANSFER SIGNALING FOR MEMORY ARRAY OPERATIONS

(71) Applicant: Micron Technology, Inc., Boise, ID (US)

(72) Inventor: Liang Yu, Boise, ID (US)

(21) Appl. No.: 19/418,638

(22) Filed: Dec. 12, 2025

Related U.S. Application Data
(60) Provisional application No. 63/738,429, filed on Dec. 23, 2024.

(51) Int. Cl. G06F 3/06

(52) U.S. Cl. CPC G06F 3/0655; G06F 3/0604; G06F 3/0679

(57) ABSTRACT

Methods, systems, and devices for data transfer signaling for memory array operations are described. A memory system may receive a first signal indicating that one or more devices are ready for a data transfer and a second signal indicating an array status. In response to the first signal and the second signal, the memory system may perform the data transfer operation during one or more programming or read operations. In some cases, the memory system, a memory device, or both, may output an indicator of a readiness to perform the data transfer, where the indication may be stored to a register, or may be sent via one or more signal lines. Further, one or more indications may include an internal indication in response to polling by a controller of the memory system. In some examples, data transfer may be postponed after a threshold time duration after transmitting the indicator.

### CROSS REFERENCE

The present Application for Patent claims priority to U.S. Provisional Ser. No. 63/738,429 by Yu, entitled “DATA TRANSFER SIGNALING FOR MEMORY ARRAY OPERATIONS,” filed Dec. 23, 2024, which is assigned to the assignee hereof, and which is expressly incorporated by reference in its entirety herein.

### TECHNICAL FIELD

The following relates to one or more systems for memory, including data transfer signaling for memory array operations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports data transfer signaling for memory array operations in accordance with examples as disclosed herein.

FIG. 2 shows an example of a current diagram that supports data transfer signaling for memory array operations in accordance with examples as disclosed herein.

FIGS. 3A and 3B show examples of a circuit diagram and a signal diagram that support data transfer signaling for memory array operations in accordance with examples as disclosed herein.

FIG. 4 shows an example of a signal diagram that supports data transfer signaling for memory array operations in accordance with examples as disclosed herein.

FIG. 5 shows a block diagram of a memory system that supports data transfer signaling for memory array operations in accordance with examples as disclosed herein.

FIGS. 6 and 7 show flowcharts illustrating a method or methods that support data transfer signaling for memory array operations in accordance with examples as disclosed herein.

### DETAILED DESCRIPTION

Memory systems, such as non-volatile memory including not-AND (NAND) memory, may in some cases include an Open NAND flash interface (ONFI) used for data transfer between one or more caches of memory devices of the memory system and a controller of the memory system. Some data transfer operations may be in response to signal that may indicate that a cache of the memory device is ready for data transfer. Data transfer operations may also, in some examples, share a power supply rail with other operations performed at a NAND device, including array programming operations, or read operations. Consequently, data transfer may in some cases overlap with one or more operations associated with relatively high current usage (e.g., word line charging for writes or reads), which may be referred to as high current operations. Overlap may result in a relatively high peak current and/or peak power for an overall current of the shared power supply rail, reducing power efficiency, as well as reducing an available portion of a power budget for other operations. In some examples, memory devices may perform one or more peak power management (PPM) operations, including predictive peak power management (e.g., pPPM), which may adjust a timing of operations to reduce peak power and overlap. However, different memory characteristics may reduce an accuracy and exactness of pPPM time management, shortening one or more windows associated with relatively low current operations—that may otherwise be used for data transfer—resulting in wasted power.

Techniques described herein may support techniques for aligning data transfer operations more accurately with low current operations. For example, a memory system may wait for one or more word line charging operations to complete. After receiving a first signal indicating that one or more devices are ready for a data transfer (e.g., a cache ready signal, a ready-busy signal) and a second signal indicating an array status (e.g., indicating completion of the word line charging operations or another indication of a next low current window), the memory system may perform the data transfer operation during one or more low current operations. In some cases, the memory system, a memory device, or both, may output an indicator of a readiness to perform the data transfer, where the indication may be stored to a register, or may be sent via one or more signal lines. Further, one or more indications may include an internal indication in response to polling by a controller of the memory system. In some examples, if the second signal (or ready/busy signal) arrives so there is not enough time to perform the data transfer before one or more high current operations, the data transfer may wait until a next low current window, or may delay the one or more high current operations.

In some examples, performing data transfer in response to both the first signal and the second signal may reduce a peak power in operations. For example, by performing data transfer in response to the first signal and the second signal, data transfer operations may be timed to fit within a window for low current operations, reducing overlap with high current operations and thereby reducing a peak power and peak current. Reduction in peak current may reduce a wear on memory systems, lead to improved power efficiency, while providing additional current budget for other operations.

In addition to applicability in memory systems as described herein, techniques supporting data transfer signaling for memory array operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by aligning performance of data transfer with programming or read algorithms to reduce peak power and avoid delays, which may reduce latency and power consumption, improve response times, improve user experience through extended battery life, among other benefits.

In addition to applicability in memory systems as described herein, techniques supporting data transfer signaling for memory array operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by aligning performance of data transfer with programming or read algorithms to reduce peak power and increase power efficiency, which may extend the life of electronic devices and thereby reduce electronic waste, among other benefits.

Features of the disclosure are illustrated and described in the context of systems, devices, and circuits. Features of the disclosure are further illustrated and described in the context of current diagrams, circuit diagrams, signal diagrams, block diagrams, and flowcharts.

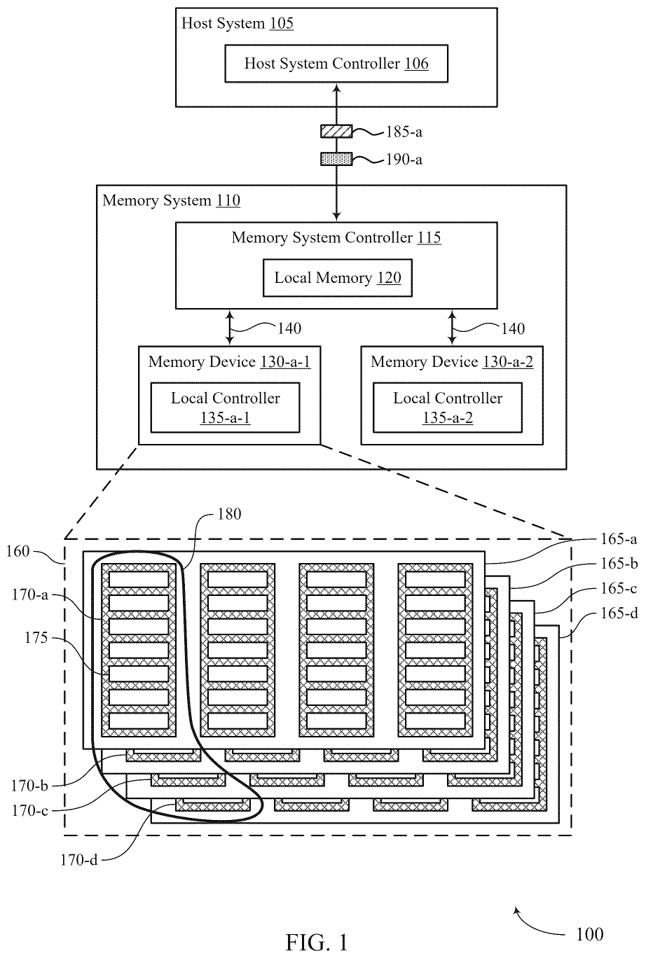

FIG. 1 shows an example of a system 100 that supports data transfer signaling for memory array operations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a-1 and 130-a-2 are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105. The memory system 110 may further include a data transfer channel 140 (e.g., an ONFI channel) between the memory devices 130 and the memory system controller 115, where the data transfer channel 140 may be shared or may include a separate channel per memory device (e.g., 4 channels, or planes, for 4 devices).

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a-1 may include a local controller 135-a-1 and a memory device 130-a-2 may include a local controller 135-a-2. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a-1 and memory device 130-a-2). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may support techniques for aligning data transfer operations more accurately with relatively low current operations as described herein. For example, the memory system 110 may wait for one or more word line charging operations to complete. After receiving a first signal indicating that one or more memory devices 130 are ready for a data transfer (e.g., a cache ready signal for local memory 120, a ready-busy signal) and a second signal indicating an array status (e.g., indicating completion of the word line charging operations or another indication of a next low current window), the memory system 110 may perform the data transfer operation to transfer data 190-a during one or more low current operations. In some cases, the memory system 110, a memory device 130, or both, may output an indicator 185-a of a readiness to perform the data transfer, where the indication 185-a may be stored to a register, or may be sent via one or more signal lines. Further, one or more indicators 185 may include an internal indication in response to polling by the memory system controller 115. In some examples, if the second signal (or ready/busy signal) arrives so there is not enough time to perform the data transfer before one or more high current operations, the data transfer may wait until a next low current window, or may delay the one or more high current operations.

The system 100 may include any quantity of non-transitory computer readable media that support data transfer signaling for memory array operations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

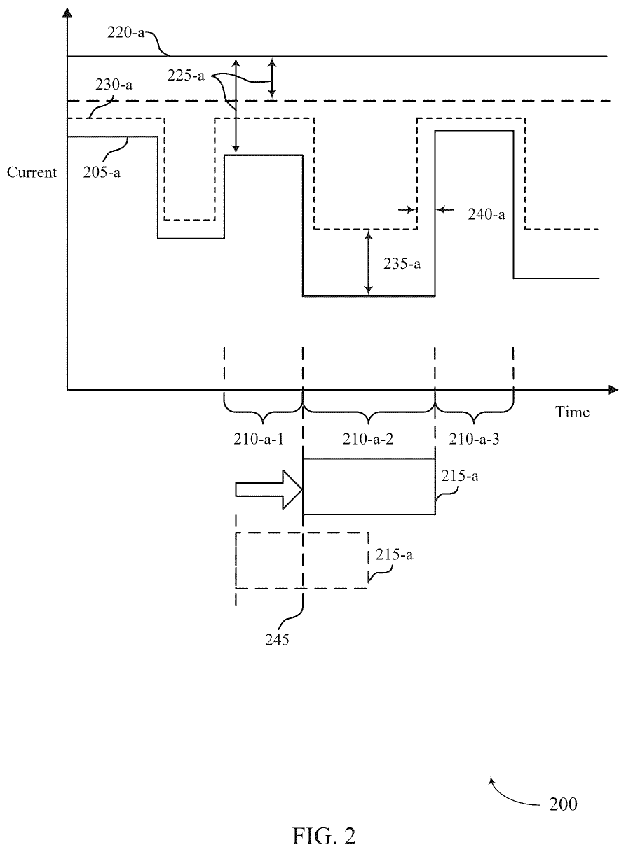

FIG. 2 shows an example of a current diagram 200 that supports data transfer signaling for memory array operations in accordance with examples as disclosed herein. One or more aspects of the current diagram 200 may implement or may be implemented by one or more aspects of the system 100. For example, the current diagram 200 may illustrate a current 205-a, which may represent a total current (e.g., an exemplary approximate total current or exemplary average total current within segments) of one or more array operations for a memory device 130 (e.g., a memory die) of a memory system 110 over time, where the one or more operations may share a power supply rail and current source. In some examples, the memory system 110 may include multiple memory devices 130 (e.g., 4 memory devices), where the current 205-a may be a current of one memory device 130 of the multiple memory devices 130. In some cases, the current diagram 200 may support data transfer signaling for memory array operations to reduce a peak current for the current 205-a.

For example, the memory device 130 corresponding to the current 205-a may perform one or more high current operations, and one or more low current operations. One or more first operations performed within a window 210-a-1 may involve charging one or more word lines for memory access, which charging may be associated with a relatively high current. Additionally, or alternatively, one or more second operations performed within a window 210-a-2 may involve one or more program operations (e.g., NAND SLC or TLC program operations), such as a static page buffer (SPB) macro operation, a program pulse operation, and a clean operation for one or more word lines, which operations may be associated with a relatively low current. Additionally, or alternatively, a window 210-a-3 may include one or more third operations also associated with a relatively high current, such as one or more verify operations to verify word line charge operations of the window 210-a-1. Other operations may also be performed.

In some cases, one or more transfer operations may overlap with the operations. For example, a window 215-a-1 may represent a duration during which transfer operations (e.g., ONFI transfer) may be performed to exchange data between a cache of the memory system 110 (e.g., a cache of an mNAND system, one or more local caches of one or more memory devices 130) with a memory system controller 115. In some examples, the window 215-a-1 may overlap with one or more high current operations performed in a portion of the window 210-a-1, and with one or more low current operations performed in a portion of the window 210-a-2. Overlapping one or more high current operations may substantially reduce a current margin of the overall memory system 110. For example, a threshold current 220-a may represent a threshold for the memory device 130 (e.g., a total budget for each memory device 130), where the overlap of the window 215-a with the window 210-a-1 may reduce a margin 225-a, or even exceed the threshold current 220-a. The overlap may result in a relatively high peak current, which may reduce performance and degrade the memory device 130, while also reducing a current available for other operations or devices that may use a same power supply rail.

In some examples, data transfer speed (e.g., ONFI speed) may increase at a rate faster than NAND array technology. For example, ONFI transfer speeds may increase so that that a transfer time (e.g., ONFI 4-plane transfer time including command overhead) may be smaller compared to the operations described with respect to the window 210-a-2. Thus, as the window 215-a decreases with increased transfer speed, the window 215-a may fit within a window for performing one or more low current operations, such as within the window 210-a-2. Additionally, or alternatively, program times may in some cases increase with technological developments.

In some cases, the memory device 130 may support one or more PPM programs. For example, a current 230-a may represent a current allocated to the memory device 130 in accordance with performing pPPM, where pPPM may involve power monitoring and communication between one or more memory devices 130 and/or memory systems 110 to adjust a timing of access and other array operations for peak current and/or power reduction (e.g., by overlapping operations accordingly). For example, a margin 235-a may be between the actual current 205-a and the current 230-a to leave room for error or fluctuations in current or for device array operations. However, pPPM may include one or more limitations associated with high current breakpoint design (e.g., design related to start and end timing of relatively high current periods). For example, pPPM may adjust power of the memory device 130 as illustrated. However, a portion of the current 230-a within the window 210-a-2 may be moved earlier or later by, for example, a time margin 240-a, so that a low current period allotted by the pPPM is smaller than the window 210-a-2. In some cases, shortening of low current periods for pPPM may be due to memory characteristics (e.g., due to an associated read window budget (RWB), or distance from an edge of a distribution of a logic level to a next read voltage level), a hot-electron (hot-e) effect (e.g., an effect where reads may increase an overall error rate), among other factors (e.g., imperfections in predictions). Imperfections and/or errors in pPPM may thus in some cases prevent a data transfer operation to fit within one or more windows, such as within the window 210-a-2.

As described herein, the memory device 130 associated with the current 205-a may support techniques for aligning data transfer operations more accurately with relatively low current operations as described herein. For example, the memory device 130 may wait to perform data transfer during the window 215-a starting at 245 (e.g., at start of program pulse, at start of SPB macro operation) until both a first signal (e.g., a cache ready signal, a ready/busy signal, among other signals) and a second signal (e.g., an array status signal indicating that the word line charging operations are complete) are received. Using the first and second signal may automatically cause a transfer current to track with one or more algorithms to fit within the window 210-a-2 (e.g., within a program pulse low current valley). In some cases, using the first signal and second signal may allow more exact timing and be more efficient compared to pPPM-based timing. Further, such operations may allow a greater current or power margin to be saved for a memory device 130, or for a set of memory devices 130, and to be used by other operations or devices. In some cases, the operations described herein may be performed for different variations of programming operations, including a 1 program 1 verify operation (e.g., 1P1V), a program without verify operation (1P0V), among other operations.

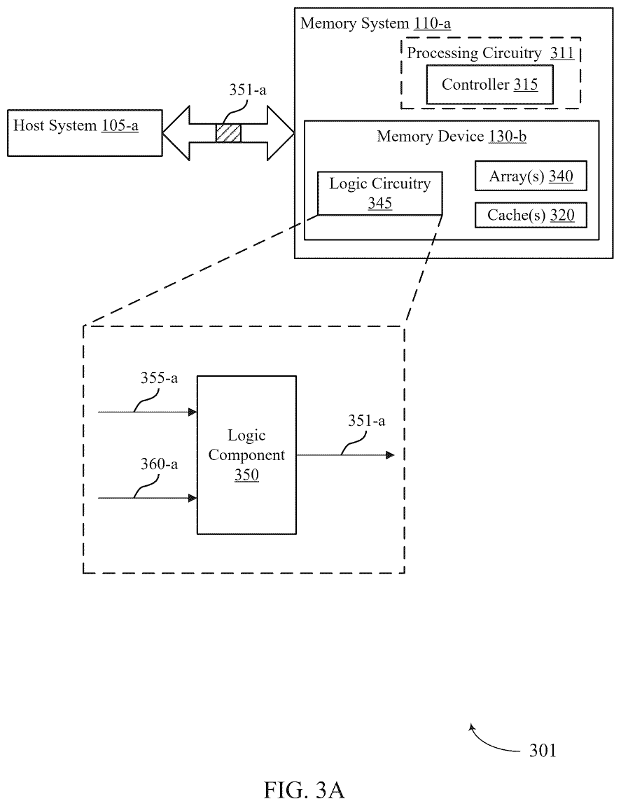

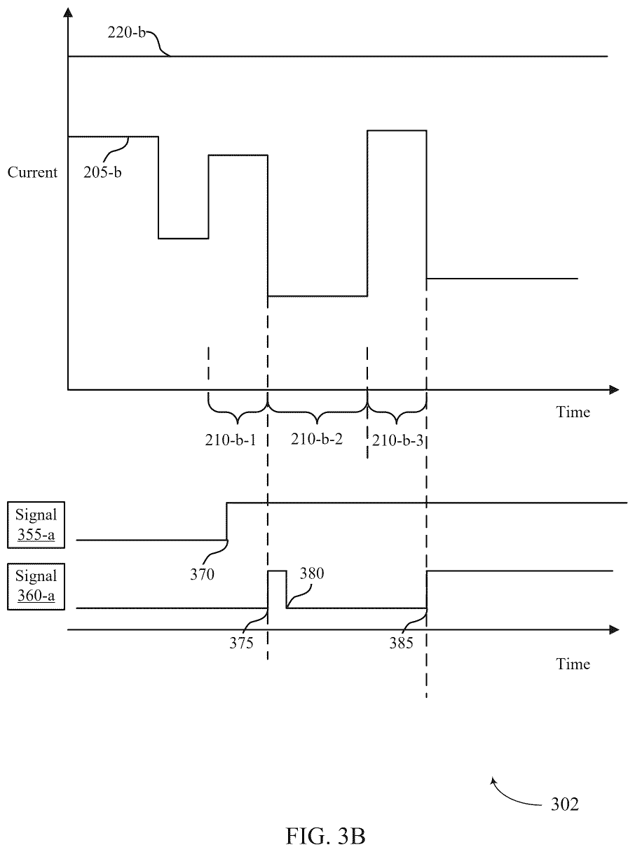

FIGS. 3A and 3B show examples of a circuit diagram 301 and a current diagram 302 that support data transfer signaling for memory array operations in accordance with examples as disclosed herein. One or more aspects of the circuit diagram 301 and the current diagram 302 may implement or may be implemented by one or more aspects of the system 100 and the current diagram 200. For example, the circuit diagram 301 may include a host system 105-a coupled with a memory system 110-a, where the memory system 110-a may include one or more memory devices 130, including a memory device 130-b, while the signal diagram 302 may illustrate a current 205-b used in one or more array operations for the memory device 130-b and of one or more signals exchanged between the components of the memory system 110-a and/or the host system 105-a. In some examples, the circuit diagram 301 and the current diagram 302 may support circuitry and data transfer signaling to reduce a peak current as described herein.

In the example of FIG. 3A, the memory system 110-a may include processing circuitry 311, which may include one or more controllers, such as a controller 315 (e.g., a memory system controller 115, an ASIC) and/or one or more local controllers of one or more memory devices 130. The memory system 110-a may also include one or more caches 320 (e.g., local memory 120, a local cache of the memory device 130-b). In some examples, the memory device 130-b may include one or more memory arrays 340 coupled with the processing circuitry 311 and including one or more sets of memory cells and a set of word lines. Additionally, or alternatively, the memory device 130-b may include logic circuitry 345 coupled with the processing circuitry 311, which may include one or more logic components 350. The processing circuitry 311 may be configured to perform one or more access operations on the one or more memory arrays 340. For example, the controller 315 and/or a local controller of the memory device 130-b may be operable to perform access operations. In some cases, the one or more memory arrays 340 may be configured to perform one or more word line charging operations for the set of word lines (e.g., controlled by the processing circuitry 311).

In some examples, the memory system 110-a may support pPPM in addition to one or more operations. For example, the memory system 110-a may receive power indications from other memory systems sharing a bus, or one or more memory devices 130 may receive power indications from other memory devices 130 sharing a bus. The memory system 110, or the memory devices 130, may adjust a timing of one or more access operations in response to the indications and a power associated with the operations of the memory system 110 or the memory devices 130. In some cases, pPPM may in some examples involve a power reservation or token. For example, a memory device 130 that is performing an operation using increased power may reserve the power (e.g., reserve power using tokens).

In some examples, the logic circuitry 345 may be operable to output, to the controller 315, an indicator 351-a of readiness to perform a data transfer operation in response to one or more signals. For example, the logic circuitry 345 may receive, at a logic component 350 (e.g., an AND component), a signal 355-a and a signal 360-a, and may output the indicator 351-a if both signals are received (e.g., if both signals indicate a respective valid signal, if both signals are a high logic level).

In some examples, the signal 360-a may indicate a status of the one or more memory arrays 340 of the memory device 130-b. For example, the one or more memory arrays 340 may, in response to completing one or more word line charging operations, output the signal 360-a to the logic circuitry 345 indicating that the one or more word line charging operations are complete. Additionally, or alternatively, the signal 355-a may indicate that the one or more caches 320 are available to perform a data transfer operation (e.g., a cache ready signal), and may be received from the one or more caches 320. In some cases, outputting the indicator 351-a may involve writing the indicator 351-a to a register (e.g., to an SR.6 register, another register) that may be operable to be polled by the controller 315, or outputting a signal directly to the controller 315. Additionally, or alternatively, the signals 355-a and 360-a may be output to one or more signal lines, buses, or via one or more pins of the memory device 130-b. In some cases, the signal 360-a may be associated with, or be in accordance with, one or more pPPM operations. In some cases, the memory system 110-a (e.g., controlled by the controller 315) may perform the data transfer operation in response to the memory device 130-b outputting the indicator 351-a.

In some examples, the controller 315 may control one or more operations by monitoring one or more signals and polling one or more internal signals. For example, the controller 315 may monitor a device status signal to determine a device status of the memory device 130-b. In some cases, the device status signal may be a ready-busy signal indicating that the memory device 130-b (or one or more additional memory devices 130) is busy, or is available to perform one or more operations, which may also be output via a signal line, bus, or pin of the memory device 130-b. In some cases, the device status signal may indicate readiness of each memory device 130 of the memory system to perform one or more operations. The controller may also monitor the signal 360-a, where the signal 360-a may indicate a state of a current associated with the one or more memory arrays 340 of the memory device 130-b (and/or of one or more additional memory devices 130). Additionally, or alternatively, the controller 315 may monitor one or more registers (e.g., the SR.6 register or another register).

In some cases, after monitoring the device status signal (or register) and the signal 360-a, the controller 315 may poll an internal indicator to determine that the one or more caches 320 (e.g., a local cache of the memory device 130-b, one or more local caches of multiple memory devices 130) are ready for a data transfer operation. For example, the indicator 351-a may in such an example be an internal indicator for the memory system 110-a, and may be stored to a register (e.g., stored as a new SR.6 register value, to a status register, to an extended status register associated with other SR read commands that may be associated with one or more bits of information, or to another register) or output via one or more signal lines. In some cases, the indicator 351-a may be in response to the signal 360-a of the memory device 130-b, as well as the signal 355-a, where the signal 355-a in such an example may be an internal ready-busy signal of the memory device 130-b. Thus, the polling may involve polling a register storing the indicator 351-a, or sending a request or command that a signal to be sent to indicate the indicator 351-a to the controller 315. The polling may also involve reading a serial bus or other signal line. In some cases, the memory system 110-a may perform the data transfer operation in response to polling the indicator 351-a and in response to the signal 360-a.

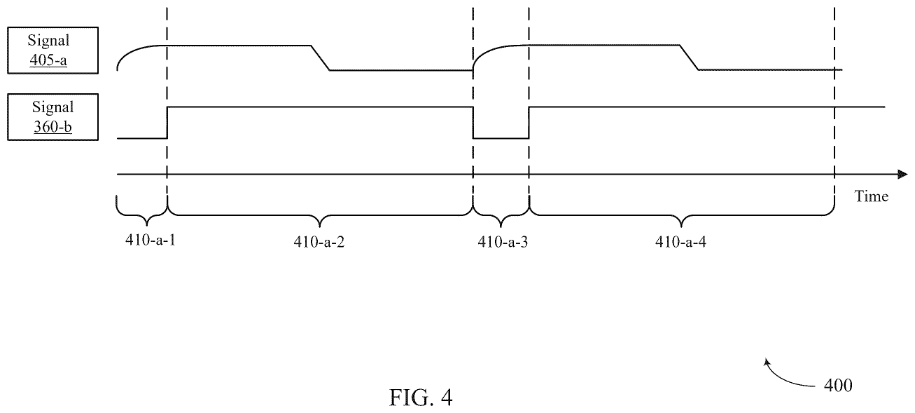

In some examples, performing the data transfer operation may involve a write operation. For example, the indicator 351-a may indicate to the controller 315 that the memory device 130-b is ready to receive write data at the one or more caches 320. In response to outputting the indicator, the one or more caches 320 may receive the data for writing and the memory device 130-b may receive one or more commands, and may write the data to the one or more memory arrays 340. In some cases, the write may be performed in response to receiving one or more commands and the data from the host system 105-a. Additionally, or alternatively, although the data transfer operation is described with respect to programming operations, similar features may be implemented for reads, as discussed in detail with respect to FIG. 4.

In the example of FIG. 3B, an example of the signals 355-a and 360-a may be shown over time. For example, the memory system 110-a (e.g., at the memory device 130-b) may perform one or more high current operations (e.g., one or more word line charging operations, one or more bit line operations) within a window 210-b-1. At 370 (during the window 210-b-1, or beforehand), the signal 355-a may change to indicate a valid signal (e.g., may go high, may change to a value of ‘1’=valid). In some cases, the change of the signal 355-a may involve a register being written to or a signal being output by the memory device 130-b as described herein.

In some cases, the memory system 110-a (e.g., the controller 315, the memory device 130-b) may refrain from performing the data transfer until a later time. For example, at 375, the signal 360-a (e.g., an array status indicating an SPB macro or pulse start, a low current phase indication such as a sense signal) may indicate a valid signal using the logic circuitry described with respect to FIG. 3A, after which the memory system 110-a may permit a data transfer operation. In some examples, if the data transfer has not started by 380, as defined by a threshold duration before initiation of data transfer, the signal 360-a may indicate an invalid signal (e.g., may go low), postponing data transfer operations and preventing overlap following high current operations. For example, if the controller 315 does not initiate a data transfer before 380, the signal 360-a may go low to delay the controller 315 from initiating the transfer between 380 and 385. In some examples, the memory system 110-a may output (e.g., from the logic circuitry 345 to the controller 315) an indicator to postpone data transfer operation if the threshold duration is satisfied. In some cases, a threshold duration (e.g., between 375 and 380) may be configured by one or more parameters in the memory system or dynamically, and may in some cases be determined using a data transfer speed. In some cases, the memory system 110-a (e.g., at the memory device 130-b) may perform additional high current operations during the window 210-b-3, including one or more verify operations for one or more word lines. At 385, the signal 360-a may indicate a valid signal again for a next low current phase following 385, where the memory device 130-b may output an indicator 351 and perform a data transfer operation. In some examples, there may be multiple similar low current phases qualified in a same program command array operation, where the signal 360-a may toggle between low current phases as illustrated in FIG. 2.

In some examples, a single timing gating (e.g., SR.6, other signal gating after SPB or pulse start) may be implemented, so that the signal 360-a remains valid after changing at 385. For example, the signal 360-a may remain valid after 385 so that a data transfer is performed regardless of whether the data transfer is able to fit within a low current window or if overlap may occur. Further, after changing a first time to be valid, if polling (e.g., by the controller 315) is late, or due to one or more ONFI gating conditions, additional polling of the signal 360-a may be omitted. In some examples, the signal 360-a may force the signal 355-a to be ready in a next qualified low current phase (e.g., after 385) if a first phase (e.g., within the window 210-b-2) is skipped or missed, regardless of the status of the signal 355-a.

In some examples, a data transfer operation may be performed in response to a total estimated current (e.g., including an estimated current of one or more operations of the memory system 110-a in addition to an estimated current of the data transfer operation) failing to satisfy a threshold current 220-b. Further, while adjusting a window for performing data transfer operations may be considered, in some cases, one or more high current operations may be postponed. For example, a start of operations for the window 210-b-3 may be delayed to within a threshold duration after the end of the window 210-b-2 to allow room for a transfer operation. In some examples, the threshold duration may be in accordance with (e.g., calculated using) a data transfer speed, quantity of operations, among other factors, and may be configured dynamically or preconfigured.

In some cases, pPPM may have a lower priority compared to adjusting data transfer operations in accordance with the signals 355-a and 360-a, or may be used in place of such operations. In other cases, pPPM may be disabled. In some examples, pPPM may be enabled or disabled by receiving one or more commands. Additionally, or alternatively, the operations described herein may be performed after any high current operation or low current operation. Further, the operations described herein may result from any combination of signals relating to array status and device readiness.

FIG. 4 shows an example of a signal diagram 400 that supports data transfer signaling for memory array operations in accordance with examples as disclosed herein. One or more aspects of the current diagram 400 may implement or may be implemented by one or more aspects of the system 100, the current diagrams 200, the circuit diagram 301, and the signal diagram 302. For example, the signal diagram 400 may represent signaling relating to one or more data transfer operations for reads performed at a memory system 110 coupled with a host system 105 and including one or more memory devices 130. In some examples, the signal diagram 400 may support data transfer signaling for read operations as described herein.

For example, a controller of a memory system 110 (e.g., the controller 315 of the memory system 110-a) may perform one or more read operations (e.g., seamless read, cache read) to read data from one or more memory arrays of one or more memory devices 130 (e.g., the one or more memory arrays 340). In some cases, a memory device of the memory system 110 may perform the read operation to read the data, and may transfer the data to a cache (e.g., the one or more caches 320) in accordance with performing one or more word line charging operations. For example, one or more word line charging operations for one or more word lines may be performed within a window 410-a. In some examples, the signal 405-a may illustrate an increasing current during the windows 410-a-1 and 410-a-3 (e.g., one or more high current operations) and a relatively stable current, or decreasing current, or combination, within the windows 410-a-2 and 410-a-4. In some cases, both selected and unselected word lines described with respect to FIG. 4 (as well as FIG. 1-B) may be charged.

In some examples, the memory device 130 may output, from one or more caches (e.g., the one or more caches 320) to the controller of the memory system 110, the data for a data transfer operation involving the one or more read operations in response to transferring the data to the cache, as well as in response to an indicator of readiness to perform the data transfer operation. For example, the signal 360-b may indicate a valid signal within the window 410-a-2 to support data transfer operations. In some cases, the one or more read operations performed within the windows 410-a-1 through 410-a-4 may be part of a same read command array operation. Additionally, or alternatively, the read data may be output to a host system 105. Additionally, or alternatively, data transfer for the read operation may be in response to a signal 355 (e.g., a register signal, a ready-busy signal) as described with respect to FIGS. 2, 3A, and 3B. In some cases, the read operations described herein may be independent from pPPM (e.g., may be enabled or disabled, or partially enabled as described herein). In some cases, pPPM may be enabled, disabled, or if running with pPPM, behaviors may be controlled by pPPM design with higher priority in logic arbitration.

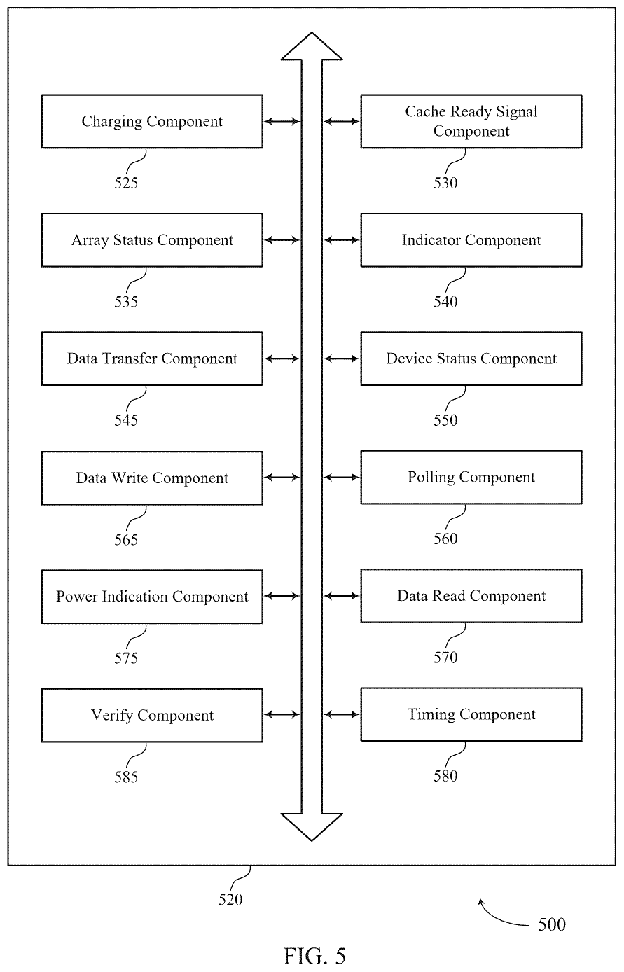

FIG. 5 shows a block diagram 500 of a memory system 520 that supports data transfer signaling for memory array operations in accordance with examples as disclosed herein. The memory system 520 may be an example of aspects of a memory system as described with reference to FIGS. 1 through 4. The memory system 520, or various components thereof, may be an example of means for performing various aspects of data transfer signaling for memory array operations as described herein. For example, the memory system 520 may include a charging component 525, a cache ready signal component 530, an array status component 535, an indicator component 540, a data transfer component 545, a device status component 550, a polling component 560, a data write component 565, a data read component 570, a power indication component 575, a timing component 580, a verify component 585, or any combination thereof. Each of these components, or components of subcomponents thereof (e.g., one or more processors, one or more memories), may communicate, directly or indirectly, with one another (e.g., via one or more buses).

The charging component 525 may be configured as or otherwise support a means for performing one or more word line charging operations for a plurality of word lines of one or more memory arrays of the memory system. The cache ready signal component 530 may be configured as or otherwise support a means for sending, from a cache of the memory system to logic circuitry of the memory system, a first signal indicating that the cache is available to perform a data transfer operation. The array status component 535 may be configured as or otherwise support a means for sending, from the one or more memory arrays of the memory system to the logic circuitry and in response to completing the one or more word line charging operations, a second signal indicating that the one or more word line charging operations are complete. The indicator component 540 may be configured as or otherwise support a means for outputting, from the logic circuitry to a controller of the memory system, an indicator of readiness to perform the data transfer operation in response to the first signal and the second signal. The data transfer component 545 may be configured as or otherwise support a means for performing the data transfer operation in response to outputting the indicator of readiness to perform the data transfer operation.

In some examples, to support outputting an indicator of readiness to perform the data transfer operation, the indicator component 540 may be configured as or otherwise support a means for storing the indicator to a register of the memory system, where the register is operable to be polled by the controller.

In some examples, to support outputting an indicator of readiness to perform the data transfer operation, the indicator component 540 may be configured as or otherwise support a means for outputting a third signal, including the indicator, to the controller.

In some examples, the data transfer component 545 may be configured as or otherwise support a means for obtaining, at the cache of the memory system and from the controller, data for the data transfer operation in response to outputting the indicator of readiness to perform the data transfer operation, where performing the data transfer operation includes obtaining the data. In some examples, the data write component 565 may be configured as or otherwise support a means for writing the data to the one or more memory arrays in response to obtaining the data.

In some examples, the data read component 570 may be configured as or otherwise support a means for reading data from the one or more memory arrays of the memory system. In some examples, the data transfer component 545 may be configured as or otherwise support a means for transferring the data to the cache in accordance with reading the data and performing the one or more word line charging operations. In some examples, the data transfer component 545 may be configured as or otherwise support a means for outputting, from the cache of the memory system and to the controller, the data for the data transfer operation in response to transferring the data to the cache and in response to the indicator of readiness to perform the data transfer operation, where the data transfer operation includes outputting the data.

In some examples, the charging component 525 may be configured as or otherwise support a means for performing one or more second word line charging operations for a second plurality of word lines of the one or more memory arrays of the memory system. In some examples, the array status component 535 may be configured as or otherwise support a means for sending, from the one or more memory arrays of the memory system to the logic circuitry and in response to completing the one or more second word line charging operations, a third signal indicating that the one or more word line charging operations are complete. In some examples, the indicator component 540 may be configured as or otherwise support a means for outputting, from the logic circuitry to the controller of the memory system, an indicator to postpone a second data transfer operation in response to a duration after sending the third signal satisfying a threshold duration prior to initiation of the second data transfer operation.

In some examples, the cache ready signal component 530 may be configured as or otherwise support a means for sending, from the cache of the memory system to the logic circuitry of the memory system, a fourth signal indicating that the cache is available to perform the second data transfer operation. In some examples, the verify component 585 may be configured as or otherwise support a means for performing one or more verify operations for the second plurality of word lines of the one or more memory arrays. In some examples, the array status component 535 may be configured as or otherwise support a means for sending, from the one or more memory arrays of the memory system to the logic circuitry and in response to completing the one or more verify operations, a fifth signal indicating that the one or more verify operations are complete. In some examples, the indicator component 540 may be configured as or otherwise support a means for outputting, from the logic circuitry to the controller of the memory system and in response to the fourth signal and the fifth signal, an indicator of readiness to perform the second data transfer operation.

In some examples, the power indication component 575 may be configured as or otherwise support a means for receiving an indication of power used by one or more other memory systems different from the memory system. In some examples, the timing component 580 may be configured as or otherwise support a means for adjusting a timing of one or more access operations associated with the one or more memory arrays of the memory system in response to the indication of power and to a power associated with one or more operations of the memory system.

In some examples, the data transfer operation is performed during a time window after the completion of the one or more word line charging operations in response to a total estimated current, including an estimated current of one or more operations of the memory system in addition to an estimated current of the data transfer operation, failing to satisfy a threshold current.

The device status component 550 may be configured as or otherwise support a means for monitoring a first signal indicating a device status of a memory device of the memory system is available to perform one or more operations. The array status component 535 may be configured as or otherwise support a means for monitoring a second signal indicating a state of a current associated with one or more memory arrays of the memory device. The polling component 560 may be configured as or otherwise support a means for polling an indicator to determine that a cache of the memory device is ready for a data transfer operation in response to monitoring the first signal and the second signal. In some examples, the data transfer component 545 may be configured as or otherwise support a means for performing the data transfer operation in response to polling the indicator and the second signal.

In some examples, to support polling the indicator of readiness to perform the data transfer operation, the polling component 560 may be configured as or otherwise support a means for polling a register of the memory device, where the register is operable to be polled by a controller of the memory system.

In some examples, to support polling the indicator of readiness to perform the data transfer operation, the polling component 560 may be configured as or otherwise support a means for receiving a third signal, including the indicator, at a controller of the memory system.

In some examples, the data transfer component 545 may be configured as or otherwise support a means for obtaining data for the data transfer operation in response to polling the indicator, where the data transfer operation includes obtaining the data.

In some examples, the data transfer component 545 may be configured as or otherwise support a means for outputting data for the data transfer operation in response to polling the indicator, where performing the data transfer operation includes outputting the data.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

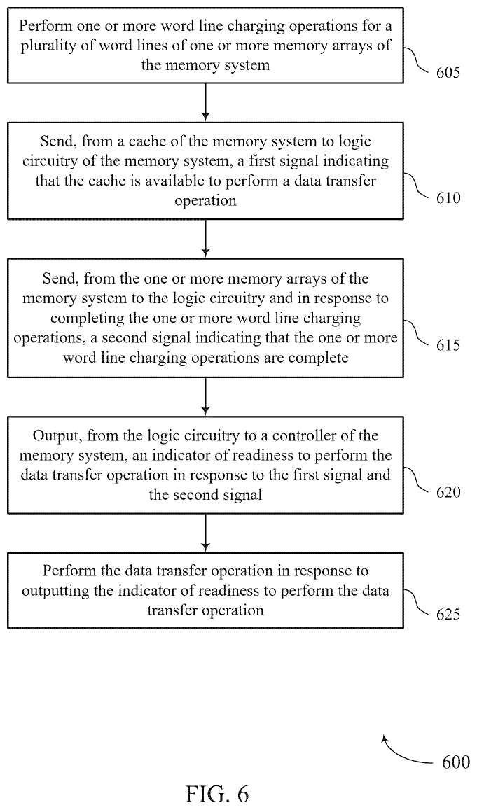

FIG. 6 shows a flowchart illustrating a method 600 that supports data transfer signaling for memory array operations in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include performing one or more word line charging operations for a plurality of word lines of one or more memory arrays of the memory system. In some examples, aspects of the operations of 605 may be performed by a charging component 525 as described with reference to FIG. 5.

At 610, the method may include sending, from a cache of the memory system to logic circuitry of the memory system, a first signal indicating that the cache is available to perform a data transfer operation. In some examples, aspects of the operations of 610 may be performed by a cache ready signal component 530 as described with reference to FIG. 5.

At 615, the method may include sending, from the one or more memory arrays of the memory system to the logic circuitry and in response to completing the one or more word line charging operations, a second signal indicating that the one or more word line charging operations are complete. In some examples, aspects of the operations of 615 may be performed by an array status component 535 as described with reference to FIG. 5.

At 620, the method may include outputting, from the logic circuitry to a controller of the memory system, an indicator of readiness to perform the data transfer operation in response to the first signal and the second signal. In some examples, aspects of the operations of 620 may be performed by an indicator component 540 as described with reference to FIG. 5.

At 625, the method may include performing the data transfer operation in response to outputting the indicator of readiness to perform the data transfer operation. In some examples, aspects of the operations of 625 may be performed by a data transfer component 545 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing one or more word line charging operations for a plurality of word lines of one or more memory arrays of the memory system; sending, from a cache of the memory system to logic circuitry of the memory system, a first signal indicating that the cache is available to perform a data transfer operation; sending, from the one or more memory arrays of the memory system to the logic circuitry and in response to completing the one or more word line charging operations, a second signal indicating that the one or more word line charging operations are complete; outputting, from the logic circuitry to a controller of the memory system, an indicator of readiness to perform the data transfer operation in response to the first signal and the second signal; and performing the data transfer operation in response to outputting the indicator of readiness to perform the data transfer operation.
Aspect 2: The method, apparatus, or non-transitory computer-readable medium of aspect 1, where outputting an indicator of readiness to perform the data transfer operation includes operations, features, circuitry, logic, means, or instructions, or any combination thereof for storing the indicator to a register of the memory system, where the register is operable to be polled by the controller.
Aspect 3: The method, apparatus, or non-transitory computer-readable medium of any of aspects 1 through 2, where outputting an indicator of readiness to perform the data transfer operation includes operations, features, circuitry, logic, means, or instructions, or any combination thereof for outputting a third signal, including the indicator, to the controller.
Aspect 4: The method, apparatus, or non-transitory computer-readable medium of any of aspects 1 through 3, further including operations, features, circuitry, logic, means, or instructions, or any combination thereof for obtaining, at the cache of the memory system and from the controller, data for the data transfer operation in response to outputting the indicator of readiness to perform the data transfer operation, where performing the data transfer operation includes obtaining the data and writing the data to the one or more memory arrays in response to obtaining the data.
Aspect 5: The method, apparatus, or non-transitory computer-readable medium of any of aspects 1 through 4, further including operations, features, circuitry, logic, means, or instructions, or any combination thereof for reading data from the one or more memory arrays of the memory system; transferring the data to the cache in accordance with reading the data and performing the one or more word line charging operations; and outputting, from the cache of the memory system and to the controller, the data for the data transfer operation in response to transferring the data to the cache and in response to the indicator of readiness to perform the data transfer operation, where the data transfer operation includes outputting the data.
Aspect 6: The method, apparatus, or non-transitory computer-readable medium of any of aspects 1 through 5, further including operations, features, circuitry, logic, means, or instructions, or any combination thereof for performing one or more second word line charging operations for a second plurality of word lines of the one or more memory arrays of the memory system; sending, from the one or more memory arrays of the memory system to the logic circuitry and in response to completing the one or more second word line charging operations, a third signal (e.g., an indicator directly sent to a controller) indicating that the one or more word line charging operations are complete; and outputting, from the logic circuitry to the controller of the memory system, an indicator to postpone a second data transfer operation in response to a duration after sending the third signal satisfying a threshold duration prior to initiation of the second data transfer operation.
Aspect 7: The method, apparatus, or non-transitory computer-readable medium of aspect 6, further including operations, features, circuitry, logic, means, or instructions, or any combination thereof for sending, from the cache of the memory system to the logic circuitry of the memory system, a fourth signal indicating that the cache is available to perform the second data transfer operation; performing one or more verify operations for the second plurality of word lines of the one or more memory arrays; sending, from the one or more memory arrays of the memory system to the logic circuitry and in response to completing the one or more verify operations, a fifth signal indicating that the one or more verify operations are complete; and outputting, from the logic circuitry to the controller of the memory system and in response to the fourth signal and the fifth signal, an indicator of readiness to perform the second data transfer operation.
Aspect 8: The method, apparatus, or non-transitory computer-readable medium of any of aspects 1 through 7, further including operations, features, circuitry, logic, means, or instructions, or any combination thereof for receiving an indication of power used by one or more other memory systems different from the memory system and adjusting a timing of one or more access operations associated with the one or more memory arrays of the memory system in response to the indication of power and to a power associated with one or more operations of the memory system.
Aspect 9: The method, apparatus, or non-transitory computer-readable medium of any of aspects 1 through 8, where the data transfer operation is performed during a time window after the completion of the one or more word line charging operations in response to a total estimated current, including an estimated current of one or more operations of the memory system in addition to an estimated current of the data transfer operation, failing to satisfy a threshold current.

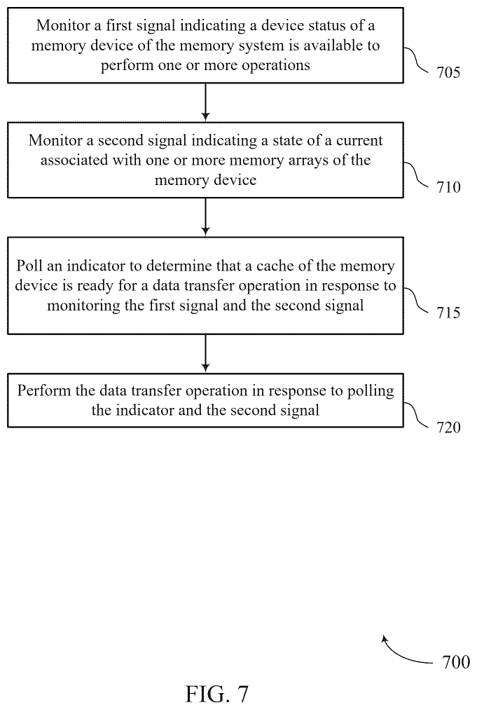

FIG. 7 shows a flowchart illustrating a method 700 that supports data transfer signaling for memory array operations in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include monitoring a first signal indicating a device status of a memory device of the memory system is available to perform one or more operations. In some examples, aspects of the operations of 705 may be performed by a device status component 550 as described with reference to FIG. 5.

At 710, the method may include monitoring a second signal indicating a state of a current associated with one or more memory arrays of the memory device. In some examples, aspects of the operations of 710 may be performed by an array status component 535 as described with reference to FIG. 5.

At 715, the method may include polling an indicator to determine that a cache of the memory device is ready for a data transfer operation in response to monitoring the first signal and the second signal. In some examples, aspects of the operations of 715 may be performed by a polling component 560 as described with reference to FIG. 5.

At 720, the method may include performing the data transfer operation in response to polling the indicator and the second signal. In some examples, aspects of the operations of 720 may be performed by a data transfer component 545 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 10: A method, apparatus, or non-transitory computer-readable medium including operations, features, circuitry, logic, means, or instructions, or any combination thereof for monitoring a first signal indicating a device status of a memory device of the memory system is available to perform one or more operations; monitoring a second signal indicating a state of a current associated with one or more memory arrays of the memory device; polling an indicator to determine that a cache of the memory device is ready for a data transfer operation in response to monitoring the first signal and the second signal; and performing the data transfer operation in response to polling the indicator and the second signal.
Aspect 11: The method, apparatus, or non-transitory computer-readable medium of aspect 10, where polling the indicator of readiness to perform the data transfer operation includes operations, features, circuitry, logic, means, or instructions, or any combination thereof for polling a register of the memory device, where the register is operable to be polled by a controller of the memory system.
Aspect 12: The method, apparatus, or non-transitory computer-readable medium of any of aspects 10 through 11, where polling the indicator of readiness to perform the data transfer operation includes operations, features, circuitry, logic, means, or instructions, or any combination thereof for receiving a third signal (e.g., a direct indication to a controller of a result of polling an SR.6 register, a requested/polled ready-busy signal, a signal sent via a serial bus, a result of another register or signal), including the indicator, at a controller of the memory system.
Aspect 13: The method, apparatus, or non-transitory computer-readable medium of any of aspects 10 through 12, further including operations, features, circuitry, logic, means, or instructions, or any combination thereof for obtaining data for the data transfer operation in response to polling the indicator, where the data transfer operation includes obtaining the data.
Aspect 14: The method, apparatus, or non-transitory computer-readable medium of any of aspects 10 through 13, further including operations, features, circuitry, logic, means, or instructions, or any combination thereof for outputting data for the data transfer operation in response to polling the indicator, where performing the data transfer operation includes outputting the data.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:
Aspect 15: A memory system, including: a cache configured to send a first signal to logic circuitry of the memory system, the first signal indicating that the cache is available to perform a data transfer operation; one or more memory arrays including one or more sets of memory cells and a plurality of word lines, the one or more memory arrays configured to perform one or more word line charging operations for the plurality of word lines and to send, in response to completing the one or more word line charging operations, a second signal indicating that the one or more word line charging operations are complete; processing circuitry coupled with the one or more memory arrays and the cache and configured to perform one or more access operations on the one or more memory arrays; and the logic circuitry coupled with the processing circuitry, the logic circuitry operable to output, to a controller of the memory system, an indicator of readiness to perform the data transfer operation in response to the first signal and the second signal, where the cache is configured to perform the data transfer operation in response to outputting the indicator.
Aspect 16: The memory system of aspect 15, further including: a register coupled with the logic circuitry, where, to output the indicator of readiness to perform the data transfer operation to the register, the logic circuitry is configured to store the indicator to the register.
Aspect 17: The memory system of any of aspects 15 through 16, where to output the indicator of readiness to perform the data transfer operation, the logic circuitry is configured to output, to the controller, a third signal including the indicator.
Aspect 18: The memory system of any of aspects 15 through 17, where: the cache is configured to obtain, from the controller, data for the data transfer operation in response to the logic circuitry outputting the indicator of readiness to perform the data transfer operation, and the processing circuitry is configured to write the data to the one or more memory arrays in response to the cache obtaining the data.
Aspect 19: The memory system of any of aspects 15 through 18, where: the processing circuitry is configured to read data from the one or more memory arrays of the memory system and to transfer the data to the cache in accordance with reading the data and the one or more memory arrays performing the one or more word line charging operations, the cache is operable to output the data to the controller in response to the data being transferred to the cache and in response to the indicator of readiness to perform the data transfer operation.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform one or more word line charging operations for a plurality of word lines of one or more memory arrays of the memory system;
send, from a cache of the memory system to logic circuitry of the memory system, a first signal indicating that the cache is available to perform a data transfer operation;
send, from the one or more memory arrays of the memory system to the logic circuitry and in response to completing the one or more word line charging operations, a second signal indicating that the one or more word line charging operations are complete;
output, from the logic circuitry to a controller of the memory system, an indicator of readiness to perform the data transfer operation in response to the first signal and the second signal; and
perform the data transfer operation in response to outputting the indicator of readiness to perform the data transfer operation.

2. The memory system of claim 1, wherein outputting an indicator of readiness to perform the data transfer operation comprises the processing circuitry configured to cause the memory system to:
store the indicator to a register of the memory system, wherein the register is operable to be polled by the controller.

3. The memory system of claim 1, wherein outputting an indicator of readiness to perform the data transfer operation comprises the processing circuitry configured to cause the memory system to:
output a third signal, comprising the indicator, to the controller.

4. The memory system of claim 1, wherein the processing circuitry is further configured to cause the memory system to:
obtain, at the cache of the memory system and from the controller, data for the data transfer operation in response to outputting the indicator of readiness to perform the data transfer operation, wherein performing the data transfer operation comprises obtaining the data; and
write the data to the one or more memory arrays in response to obtaining the data.

5. The memory system of claim 1, wherein the processing circuitry is further configured to cause the memory system to:
read data from the one or more memory arrays of the memory system;
transfer the data to the cache in accordance with reading the data and performing the one or more word line charging operations; and
output, from the cache of the memory system and to the controller, the data for the data transfer operation in response to transferring the data to the cache and in response to the indicator of readiness to perform the data transfer operation, wherein the data transfer operation comprises outputting the data.

6. The memory system of claim 1, wherein the processing circuitry is further configured to cause the memory system to:
perform one or more second word line charging operations for a second plurality of word lines of the one or more memory arrays of the memory system;
send, from the one or more memory arrays of the memory system to the logic circuitry and in response to completing the one or more second word line charging operations, a third signal indicating that the one or more word line charging operations are complete; and
output, from the logic circuitry to the controller of the memory system, an indicator to postpone a second data transfer operation in response to a duration after sending the third signal satisfying a threshold duration prior to initiation of the second data transfer operation.

7. The memory system of claim 6, wherein the processing circuitry is further configured to cause the memory system to:
send, from the cache of the memory system to the logic circuitry of the memory system, a fourth signal indicating that the cache is available to perform the second data transfer operation;
perform one or more verify operations for the second plurality of word lines of the one or more memory arrays;
send, from the one or more memory arrays of the memory system to the logic circuitry and in response to completing the one or more verify operations, a fifth signal indicating that the one or more verify operations are complete; and
output, from the logic circuitry to the controller of the memory system and in response to the fourth signal and the fifth signal, an indicator of readiness to perform the second data transfer operation.

8. The memory system of claim 1, wherein the processing circuitry is further configured to cause the memory system to:
receive an indication of power used by one or more other memory systems different from the memory system; and
adjust a timing of one or more access operations associated with the one or more memory arrays of the memory system in response to the indication of power and to a power associated with one or more operations of the memory system.

9. The memory system of claim 1, wherein the data transfer operation is performed during a time window after the completion of the one or more word line charging operations in response to a total estimated current, comprising an estimated current of one or more operations of the memory system in addition to an estimated current of the data transfer operation, failing to satisfy a threshold current.

10. A memory system, comprising:
one or more memory devices; and
processing circuitry coupled with the one or more memory devices and configured to cause the memory system to:
monitor a first signal indicating a device status of a memory device of the memory system is available to perform one or more operations;
monitor a second signal indicating a state of a current associated with one or more memory arrays of the memory device;
poll an indicator to determine that a cache of the memory device is ready for a data transfer operation in response to monitoring the first signal and the second signal; and
perform the data transfer operation in response to polling the indicator and the second signal.

11. The memory system of claim 10, wherein polling the indicator of readiness to perform the data transfer operation comprises the processing circuitry configured to cause the memory system to:
poll a register of the memory device, wherein the register is operable to be polled by a controller of the memory system.

12. The memory system of claim 10, wherein polling the indicator of readiness to perform the data transfer operation comprises the processing circuitry configured to cause the memory system to:
receive a third signal, comprising the indicator, at a controller of the memory system.

13. The memory system of claim 10, wherein the processing circuitry is further configured to cause the memory system to:
obtain data for the data transfer operation in response to polling the indicator, wherein the data transfer operation comprises obtaining the data.

14. The memory system of claim 10, wherein the processing circuitry is further configured to cause the memory system to:
output data for the data transfer operation in response to polling the indicator, wherein performing the data transfer operation comprises outputting the data.

15. The memory system of claim 10, wherein the processing circuitry is further configured to cause the memory system to:
receive an indication of power used by one or more other memory systems different from the memory system; and
adjust a timing of one or more access operations associated with the one or more memory arrays of the memory system in response to the indication of power and to a power associated with one or more operations of the memory system.

16. The memory system of claim 10, wherein the data transfer operation is performed during a time window after a completion of one or more word line charging operations in response to a total estimated current, comprising an estimated current of one or more operations of the memory system in addition to an estimated current of the data transfer operation, failing to satisfy a threshold current.

17. A memory system, comprising:
a cache configured to send a first signal to logic circuitry of the memory system, the first signal indicating that the cache is available to perform a data transfer operation;
one or more memory arrays comprising one or more sets of memory cells and a plurality of word lines, the one or more memory arrays configured to perform one or more word line charging operations for the plurality of word lines and to send, in response to completing the one or more word line charging operations, a second signal indicating that the one or more word line charging operations are complete;
processing circuitry coupled with the one or more memory arrays and the cache and configured to perform one or more access operations on the one or more memory arrays; and
the logic circuitry coupled with the processing circuitry, the logic circuitry operable to output, to a controller of the memory system, an indicator of readiness to perform the data transfer operation in response to the first signal and the second signal, wherein the cache is configured to perform the data transfer operation in response to outputting the indicator.

18. The memory system of claim 17, further comprising:
a register coupled with the logic circuitry, wherein, to output the indicator of readiness to perform the data transfer operation to the register, the logic circuitry is configured to store the indicator to the register.

19. The memory system of claim 17, wherein to output the indicator of readiness to perform the data transfer operation, the logic circuitry is configured to output, to the controller, a third signal comprising the indicator.

20. The memory system of claim 17, wherein:
the cache is configured to obtain, from the controller, data for the data transfer operation in response to the logic circuitry outputting the indicator of readiness to perform the data transfer operation, and
the processing circuitry is configured to write the data to the one or more memory arrays in response to the cache obtaining the data.

21. The memory system of claim 17, wherein:
the processing circuitry is configured to read data from the one or more memory arrays of the memory system and to transfer the data to the cache in accordance with reading the data and the one or more memory arrays performing the one or more word line charging operations, and
the cache is operable to output the data to the controller in response to the data being transferred to the cache and in response to the indicator of readiness to perform the data transfer operation.

22. The memory system of claim 17, wherein the data transfer operation is performed during a time window after the completion of the one or more word line charging operations in response to a total estimated current, comprising an estimated current of one or more operations of the memory system in addition to an estimated current of the data transfer operation, failing to satisfy a threshold current.
